(19) United States
(12) Patent Application Publication
(10) Pub. No.: US 2006/0106864 A1
(43) Pub. Date: May 18, 2006

(54) System, computer program product and method of narrowing an enterprise Java bean (EJB) object reference to a home implementation class name

(75) Inventor: Scott J. Broussard, Cedar Park, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/988,283

(22) Filed: Nov. 12, 2004

(51) Int. Cl. G06F 17/00; G06F 7/00

(52) U.S. Cl. 707/103 Z

(57) ABSTRACT

A system, computer program product and method of narrowing an enterprise Java bean (EJB) object reference to a home implementation class name are provided. To obtain the class name, the location of the EJB in a network is first obtained by performing a JNDI lookup. Using the location, an IOR of the EJB is obtained. The IOR is then processed to obtain the home implementation class name of the object. Processing the IOR includes decomposing the IOR to arrive at a typeId string stored therein. The typeId string is further processed to obtain the home implementation class name contained therein.

### BACKGROUND OF THE INVENTION

1. Technical Field

The present invention is directed to J2EE software applications. More specifically, the present invention is directed to a system, computer program product and method of narrowing an EJB object reference to a home implementation class name.

2. Description of Related Art

Java™, an object-oriented programming language developed by Sun Microsystems, Inc., is platform-independent, and networking/distributed-computing friendly. As a distributed-computing friendly programming language, Java provides for naming and directory services. A naming service provides a mechanism for giving names to objects so they can be used without knowing their storage location. A directory service, on the other hand, associates names with objects. Some directory services may provide additional information by associating attributes with the objects.

Java provides for naming and directory services through Java Naming and Directory Interface (JNDI). JNDI is a Java application program interface (API) for accessing naming and directory Services. That is, JNDI is an API and not, in itself, a naming and directory service. To use JNDI, an implementation of a naming and directory service, such as Lightweight Directory Access Protocol (LDAP), Domain Name System (DNS), Novell Directory Services (NDS), Network Information Service (NIS) etc. must also be available. JNDI also supports more specialized naming systems such as the Common Object Request Broker Architecture (CORBA) and the Remote Method Invocation (RMI). CORBA is an open distributed object computing infrastructure that is being standardized by the Object Management Group (OMG). CORBA automates many common network programming tasks such as object registration, location, activation et cetera. RMI allows an object running in one Java Virtual Machine (JVM) to invoke methods on an object running in another JVM. That is, RMI provides for remote communication between programs written in the Java programming language.

In its simplest form, JNDI is used to find resources, such as Enterprise Java Beans (EJBs) that have been registered via a Java 2 platform Enterprise Edition (J2EE) server. J2EE is a platform-independent, Java-centric environment for developing, building and deploying Web-based enterprise applications online. The J2EE platform consists of a set of services, APIs, and protocols that provide functionality for developing multi-tiered, Web-based applications. J2EE applications allow for deployment-time binding while maintaining type and link safety by having each component export a list of needed external components and resources. Thus, in a J2EE application, components find other components not via static linking, but through JNDI lookups.

When a JNDI lookup for an EJB is performed, a lookup( ) method is executed. The lookup( ) method generally returns a reference to the EJB (or an object reference) that in EJB version 1.0 would have to be cast to the home interface of the EJB. Casting is an explicit conversion from one data type to another. A data type is a named category of data that is characterized by a set of values, together with a way to denote those values and a collection of operations that interpret and manipulate the values. However, in EJB version 1.1 casting is not permitted.

Specifically, the communication between an EJB server and client is based on RMI. RMI, as mentioned above, is a set of protocols that enables Java objects to communicate remotely with other Java objects. Unlike CORBA, which is designed to support objects created in any language, RMI works only with Java objects.

The underlying protocol that RMI used for the communication is Internet Inter-Orb Protocol (IIOP), which is part of CORBA. IIOP is a protocol developed by the Object Management Group (OMG) to implement CORBA solutions over the World Wide Web. IIOP enables browsers and servers to exchange integers, arrays, and more complex objects. Since IIOP is part of CORBA, it has not been designed for Java, but rather for generic languages, and as such it has some limitations. One of its limitations is that it does not allow for casting.

Nonetheless, Java RMI-IIOP provides a mechanism to convert an object type received from a lookup( ) method to an appropriate type. This is done through a narrow( ) method. To use the narrow( ) method, however, a remote reference to a home implementation class name of the EJB must be known. This will allow the EJB to be called for instantiation without error. But, in cases where the EJB instance is being treated as an interface implementation, the home implementation class name is not known. An interface defines operations or methods that a class implements (i.e., declares what a class does). A class is used to instantiate or create objects in memory.

Thus, there is a need for a system, computer program product and method of dynamically determining EJB home implementation class names.

### SUMMARY OF THE INVENTION

The present invention provides a system, computer program product and method of narrowing an enterprise Java bean (EJB) object reference to a home implementation class name. Generally, when a Java Naming and Directory Interface lookup is performed for an EJB, an object reference is returned. In the case of the invention, an interoperable object reference (IOR) associated with the object is also obtained. The IOR contains information that may lead to the home implementation class name of the object. Once the class name is obtained, the object may be instantiated.

Thus, the invention first determines the location of the EJB in a network by performing a JNDI lookup. Using the location, an IOR of the EJB is obtained. The IOR is then processed to obtain the home implementation class name of the object. Processing the IOR includes decomposing the IOR to arrive at a typeId string stored therein. The typeId string is further processed to obtain the home implementation class name contained therein.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts an exemplary stringified interoperable object reference (IOR).

FIG. 5 is a flowchart of a process that may be used to implement the invention.

### DETAILED DESCRIPTION OF THE PREFERRED EMBODIMENT

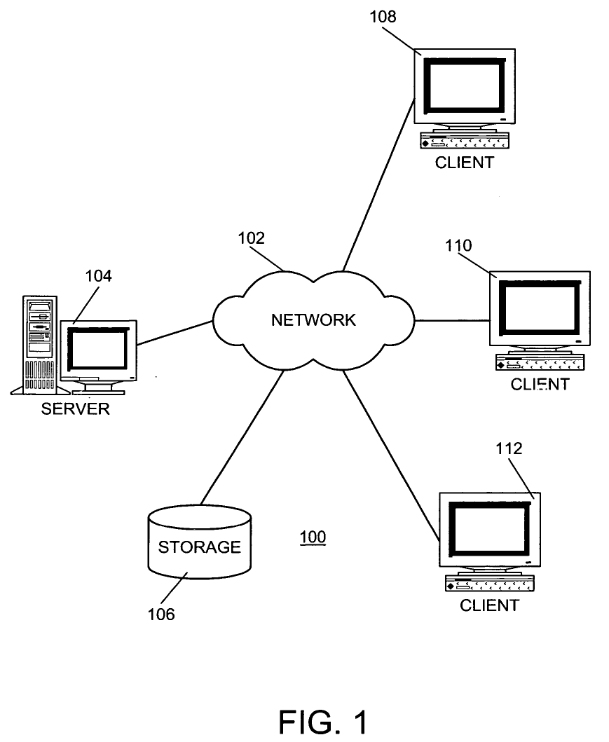

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

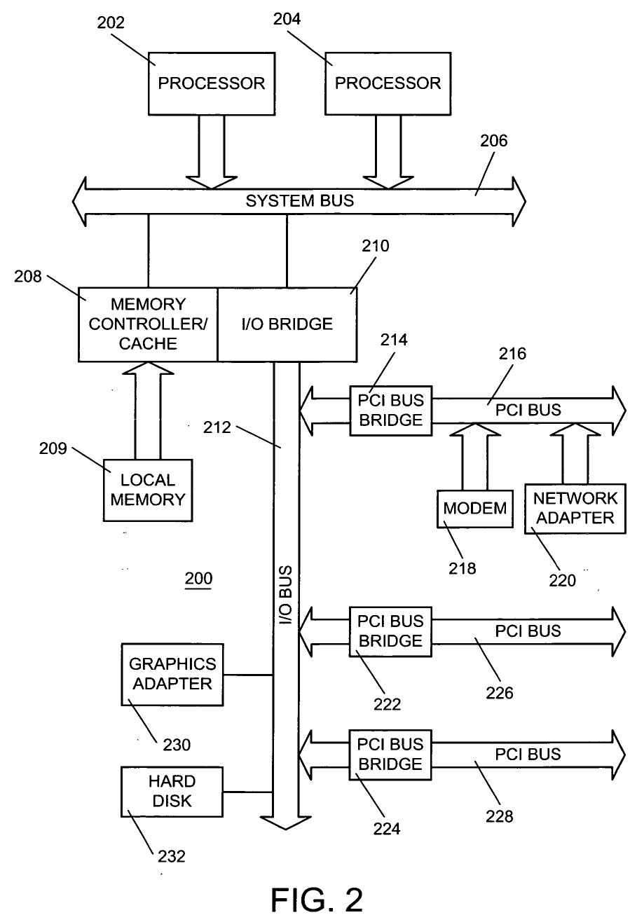

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

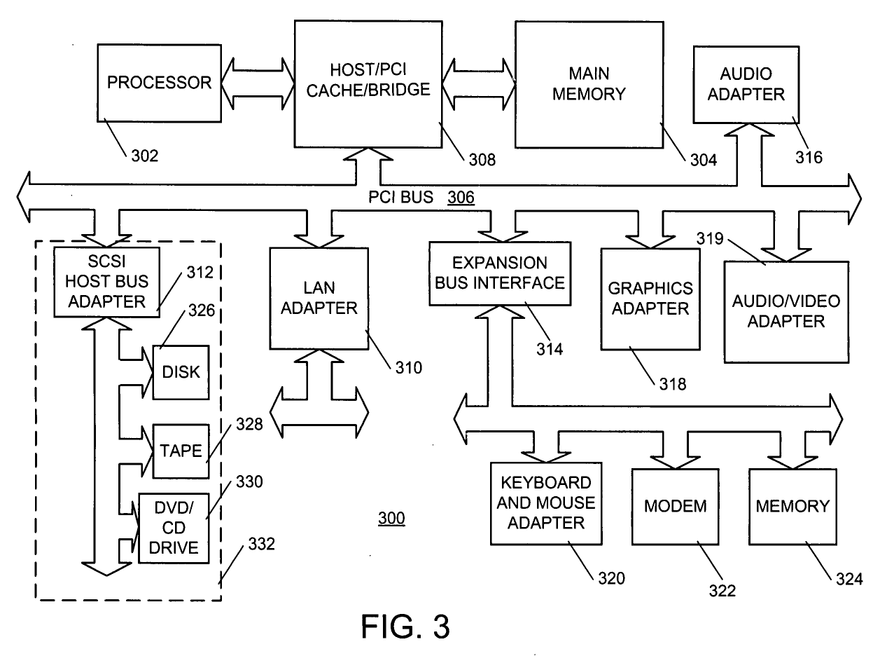

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP™, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, computer program product and method of dynamically determining EJB home implementation class names for narrowing purposes. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

Generally, objects publish their identities and locations via object references. In CORBA, object references are exchanged over IIOP in the form of interoperable object reference (IOR). An IOR is a data structure associated with an object that contains enough information to locate the object from anywhere on a network. Put simply, an IOR allows an application to make remote method calls on an object. To do so, an IOR usually contains one or more profiles. A profile describes how a client can contact and send requests to the object using a particular protocol. The profile contains the Internet address of the object's server and a key value used by the server to find the specific object described by the reference.

Typically, the application that creates a CORBA object produces a file containing a stringified IOR. To use a CORBA object, an application has to obtain the stringified IOR from the file in which it is stored, and call the object request broker's (ORB's) string_to_object method( ). This method will convert the string to a real CORBA object reference for use.

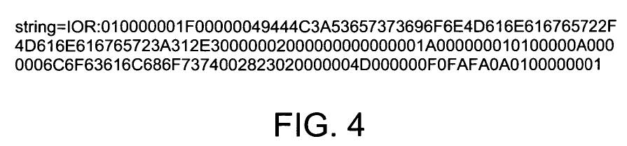

FIG. 4 depicts an exemplary stringified IOR. As can be seen, the stringified IOR is in the form of IOR:###. Within the IOR is a “typeId string.” The “typeId string contains, among other information, the class name of the object. Using the class name, the returned object reference can be narrowed to an appropriate specific class that enables the create() method to be called without error.

Thus, in operation, if server 104 is a J2EE server with which an EJB is registered. And, if an application on one of the clients 108, 110 and 112 wants to dynamically link to the EJB, the application may perform a JNDI lookup for the EJB. As mentioned before, an object reference to the EJB will be returned to the application. Further, the application may use a utility method to retrieve the IOR of the RMI/IIOP CORBA object. Once the IOR is obtained, it may be decomposed to isolate the “typeId string.” From the “typeId string,” the class name of the object may be obtained. Using the class name of the object, the application may call the object for instantiation.

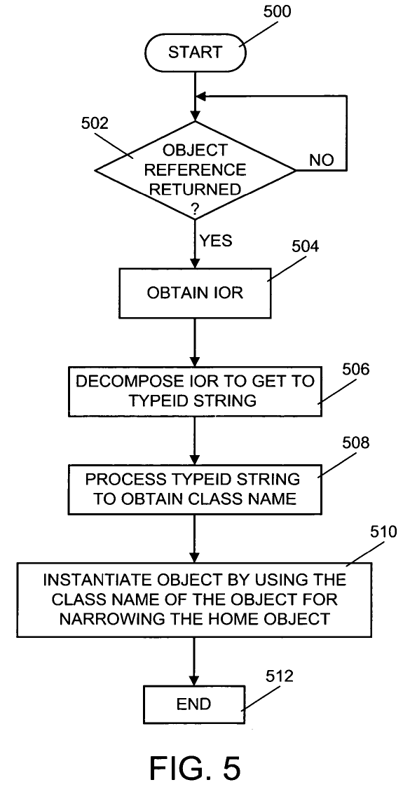

FIG. 5 is a flowchart of a process that may be used to implement the invention. The process starts when a JNDI lookup is performed (step 500). After the JNDI lookup has been initiated, the process waits for an object reference to the object to be returned (step 502). Once the object reference is returned, the IOR of the object is obtained (step 504) and decomposed to get to the typeId string (step 506). The typeId string is processed to obtain a particular class name of the object (step 508). The class is then called to instantiate the object (step 510) before the process ends (step 512).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of narrowing an object reference to an enterprise Java bean (EJB) to a home implementation class name of the EJB comprising the steps of:
determining a location where the EJB is stored;
obtaining, using the location, an interoperable object reference (IOR) of the EJB; and
processing the IOR to obtain the home implementation class name of the object.

2. The method of claim 1 wherein the determining step includes the step of performing a Java Naming and Directory Interface (JNDI) lookup of the EJB.

3. The method of claim 2 wherein the processing step includes the step of decomposing the IOR to arrive at a typeId string stored therein.

4. The method of claim 3 wherein the processing step further includes the step of processing the typeId string to obtain the home implementation class name contained therein.

5. The method of claim 2 wherein an object reference is returned in response to the JNDI lookup, the object reference being used to obtain the IOR.

6. The method of claim 5 wherein the IOR obtained is a stringified IOR that is converted to a Common Object Request Broker Architecture (CORBA) object reference.

7. A computer program product on a computer readable medium for narrowing an object reference to an enterprise Java bean (EJB) to a home implementation class name of the EJB comprising:
code means for determining a location where the EJB is stored;
code means for obtaining, using the location, an interoperable object reference (IOR) of the EJB; and
code means for processing the IOR to obtain the home implementation class name of the object.

8. The computer program product of claim 7 wherein the determining code means includes code means for performing a Java Naming and Directory Interface (JNDI) lookup of the EJB.

9. The computer program product of claim 8 wherein the processing code means includes code means for decomposing the IOR to arrive at a typeId string stored therein.

10. The computer program product of claim 9 wherein the processing code means further includes code means for processing the typeId string to obtain the home implementation class name contained therein.

11. The computer program product of claim 8 wherein an object reference is returned in response to the JNDI lookup, the object reference being used to obtain the IOR.

12. The computer program product of claim 11 wherein the IOR obtained is a stringified IOR that is converted to a Common Object Request Broker Architecture (CORBA) object reference.

13. A system for narrowing an object reference to an enterprise Java bean (EJB) to a home implementation class name of the EJB comprising:
at least of storage device for storing code data; and
at least one processor for processing the code data to determine a location where the EJB is stored, to obtain, using the location, an interoperable object reference (IOR) of the EJB, and to process the IOR to obtain the home implementation class name of the object.

14. The system of claim 13 wherein the code data includes code data to perform a Java Naming and Directory Interface (JNDI) lookup of the EJB.

15. The system of claim 14 wherein the code data includes code data to decompose the IOR to arrive at a typeId string stored therein.

16. The system of claim 15 wherein the code data further includes code data to process the typeId string to obtain the home implementation class name contained therein.

17. The system of claim 14 wherein an object reference is returned in response to the JNDI lookup, the object reference being used to obtain the IOR.

18. The system of claim 17 wherein the IOR obtained is a stringified IOR that is converted to a Common Object Request Broker Architecture (CORBA) object reference.
